(19) United States
(12) Patent Application Publication
(10) Pub. No.: US 2010/0123396 A1
(43) Pub. Date: May 20, 2010

(54) REPLACEABLE LAMP BODIES FOR ELECTRODELESS PLASMA LAMPS

(75) Inventors: Marc DeVincentis, Palo Alto, CA (US); Anthony D. McGettigan, Santa Rosa, CA (US); Abdeslam Hafidi, Cupertino, CA (US); Gregg Hollingsworth, Tempe, AZ (US)

Correspondence Address: SCHWEGMAN, LUNDBERG & WOESSNER, P.A., P.O. BOX 2938, MINNEAPOLIS, MN, 55402, US

(73) Assignee: Luxim Corporation, Sunnyvale, CA (US)

(21) Appl. No.: 12/576,895

(22) Filed: Oct. 9, 2009

Related U.S. Application Data
(60) Provisional application No. 61/104,014, filed on Oct. 9, 2008.

(51) Int. Cl. H05B 41/24; H01J 7/24

(52) U.S. Cl. 315/112; 315/248

(57) ABSTRACT

An electrodeless plasma lamp comprising a lamp housing and a lamp body releasably received with the lamp housing. The lamp housing includes a first electrical connector operatively coupled a power source to provide radio frequency (RF) power. The lamp body includes a second electrical connector to releasably engage with the first electrical connector of the lamp housing. The lamp body includes a dielectric material having a relative permittivity greater than 2. RF power is coupled by the lamp body to a bulb containing a fill that forms a light emitting plasma. In an example embodiment, the plasma lamp includes a retaining arrangement releasably to retain the lamp body at least partially within the lamp housing.

### CLAIM OF PRIORITY

The present application claims the benefit under 35 U.S.C. 119(e) of U.S. Provisional Patent Application Ser. No. 61/104,014, filed Oct. 9, 2008, which is incorporated herein by reference in its entirety.

### BACKGROUND

### I. Field

This disclosure relates to systems and methods for generating light, and more particularly to radio frequency powered discharge lamps.

### II. Background

Electrodeless plasma lamps can offer long operating lifetimes but, nevertheless, still fail after prolonged use. These plasma lamps include a bulb that includes a light emitting plasma when radio frequency power is coupled to the bulb. Bulbs typically wear out more quickly than any other components of a plasma lamp system.

### BRIEF DESCRIPTION OF THE DRAWINGS

Embodiments are illustrated by way of example, and not limitation, in the figures of the accompanying drawings, in which like references indicate similar elements unless otherwise indicated. In the drawings:

FIG. 1 is a cross-section and schematic view of a plasma lamp according to an example embodiment;

FIG. 2A shows an exploded cross-section view of a plasma lamp, in accordance with an example embodiment, including a lamp housing and replaceable lamp body;

FIG. 2B shows an assembled cross-section view of the plasma lamp of FIG. 2A;

FIG. 3A shows an exploded cross-section view of a further plasma lamp, in accordance with an example embodiment, including a lamp housing and replaceable lamp body;

FIG. 3B shows an assembled cross-section view of the plasma lamp of FIG. 3A;

FIG. 4A shows an exploded cross-section view of a yet further plasma lamp, in accordance with an example embodiment, including a lamp housing and replaceable lamp body; and

FIG. 4B shows an assembled cross-section view of the plasma lamp of FIG. 4A.

### DETAILED DESCRIPTION

While the present invention is open to various modifications and alternative constructions, the embodiments shown in the drawings will be described herein in detail. It is to be understood, however, there is no intention to limit the invention to the particular forms disclosed. On the contrary, it is intended that the invention cover all modifications, equivalences and alternative constructions falling within the spirit and scope of the invention as expressed in the appended claims.

In an example embodiment, an electrodeless plasma lamp comprises a lamp housing and a lamp body releasably received with the lamp housing. The lamp housing includes a first electrical connector operatively coupled a power source to provide radio frequency (RF) power The lamp body includes a second electrical connector to releasably engage with the first electrical connector of the lamp housing. In an example embodiment, the plasma lamp includes a retaining arrangement releasably to retain the lamp body at least partially within the lamp housing. As the lamp body is releasably mounted and connected to the lamp housing, removal and replacement of the lamp body by a service technician is facilitated. In an example embodiment, the retaining arrangement includes a simple mechanical fastener that may be easily undone. Thus, no soldering iron or other tools are required to replace, for example, a defective plasma lamp body.

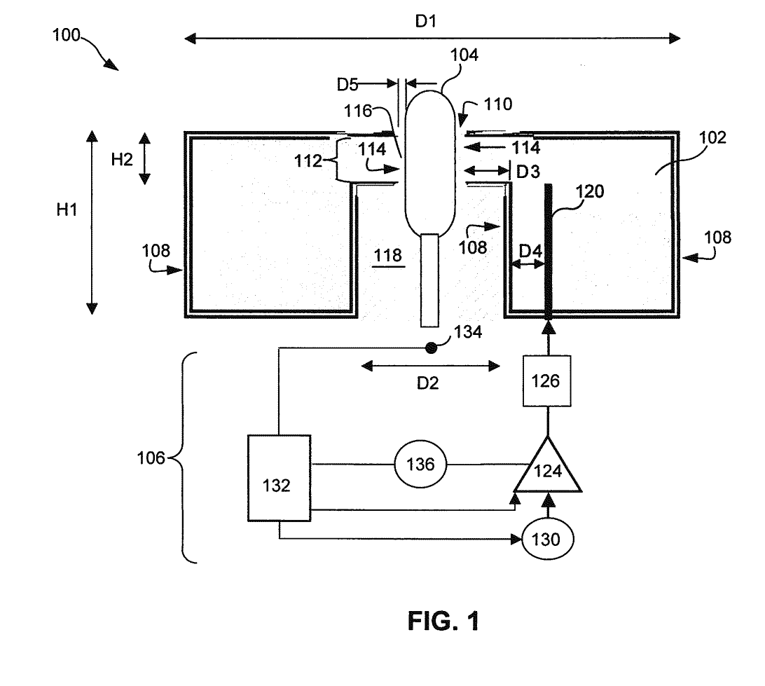

Example embodiments provide for lamp body replacement in RF powered plasma lamps. FIG. 1 is a cross-section and schematic view of electrodeless plasma lamp 100 in accordance with an example embodiment. It should be noted that the plasma lamp 100 is merely an example and other plasma lamps may be used with other embodiments, including microwave, capacitive or inductive plasma lamps or other high intensity discharge lamps.

In the example embodiment of FIG. 1, the plasma lamp 100 may have a lamp body 102 formed from one or more solid dielectric materials and a bulb 104 positioned adjacent to the lamp body 102. The lamp body 102 includes a dielectric material having a dielectric constant (relative permittivity) greater than 2. The bulb 104 contains a fill that is capable of forming a light emitting plasma when radio frequency (RF) power is coupled to the bulb 104. A lamp drive circuit 106 provides RF to the lamp body 102 which, in turn, is coupled to the fill in the bulb 104 to form the light emitting plasma. In example embodiments, the lamp body 102 forms a waveguide that contains and guides the radio frequency power. In example embodiments, the RF power may be provided at or near a frequency that resonates within the lamp body 102. This is an example only and some embodiments may use a different electrodeless plasma lamp, such as a capacitively or inductively coupled plasma lamp, or other high intensity discharge lamp.

The plasma lamp 100 is shown to have a drive probe 120 inserted into the lamp body 102 to provide RF power to the lamp body 102. The lamp drive circuit 106 including a power supply, such as a voltage controlled oscillator 130 and an amplifier 124, may be coupled to the drive probe 120 through a low pass filter 126 to provide the RF power. In an example embodiment, the lamp drive circuit 106 is matched to the load (formed by the lamp body 102, bulb 104 and plasma) for the steady state operating conditions of the plasma lamp 100. In an example embodiment, the lamp drive circuit 106 is matched to the load at the drive probe 120 using a matching network 126. A photodetector 134, a microprocessor 132, and a current sensor 136 may be used to control the drive circuit 106 during operation of the plasma lamp 100.

In example embodiments, the RF power may be provided at a frequency in the range of between about 50 MHz and about 10 GHz or any range subsumed therein. The RF power may be provided to the drive probe 120 at or near a resonant frequency for the lamp body 102. The frequency may be selected based on the dimensions, shape and relative permittivity of the lamp body 102 to provide resonance in the lamp body 102. In example embodiments, the frequency is selected for a fundamental resonant mode of the lamp body 102, although higher order modes may also be used in some embodiments. In example embodiments, the RF power may be applied at a resonant frequency or in a range of from 0% to 10% above or below the resonant frequency or any range subsumed therein. In some embodiments, RF power may be applied in a range of from 0% to 5% above or below the resonant frequency. In some embodiments, power may be provided at one or more frequencies within the range of about 0 to 50 MHz above or below the resonant frequency or any range subsumed therein. In another example embodiment, the RF power may be provided at one or more frequencies within the resonant bandwidth for at least one resonant mode. The resonant bandwidth is the full frequency width at half maximum of power on either side of the resonant frequency (on a plot of frequency versus power for the resonant cavity).

In some example embodiments, the RF power is provided by an RF wave coupling. The RF power may be coupled at a frequency that forms a standing wave in the lamp body 102 (sometimes referred to as a sustained waveform discharge or microwave discharge when using microwave frequencies). In other embodiments, a capacitively coupled or inductively coupled electrodeless plasma lamp may be used. Other high intensity discharge lamps may be used in other embodiments.

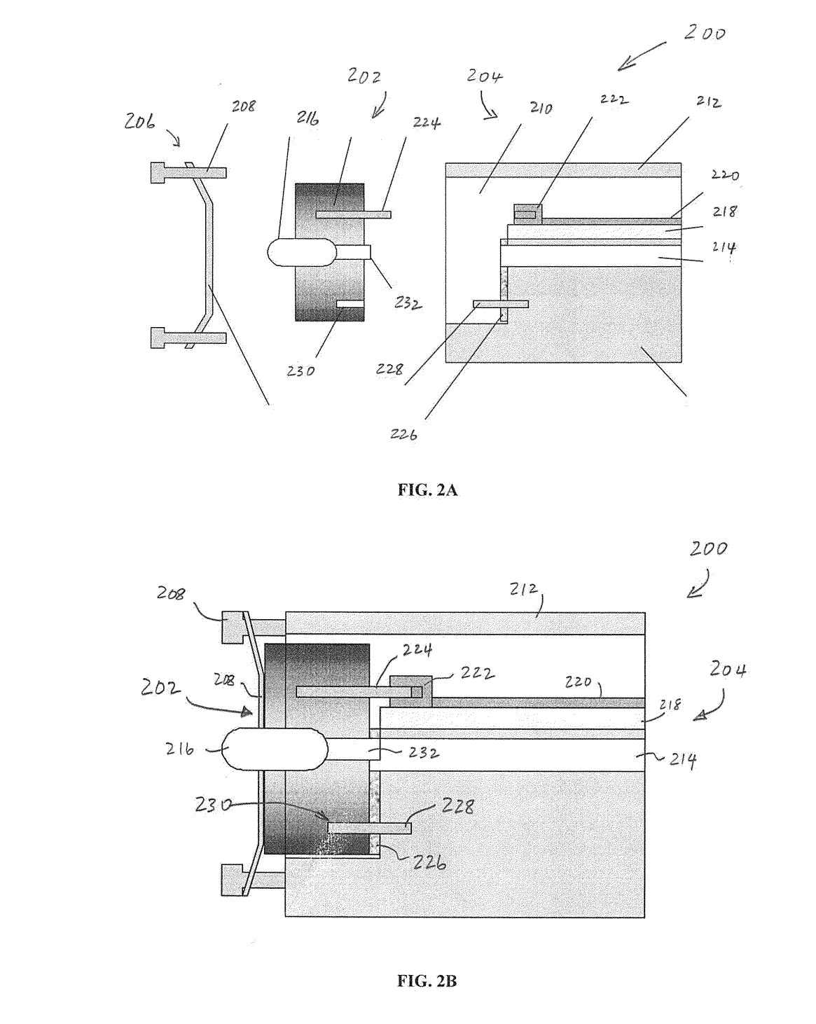

FIG. 2A shows an exploded cross-section view of an electrodeless plasma lamp 200. FIG. 2B depicts an assembled view of the plasma lamp 200 shown in FIG. 2A.

The plasma lamp 200 comprises an assembly of a replaceable lamp body 202 and lamp housing 204 with associated parts that enable replacement. The lamp housing 204 and its associated components constitute the portion of the electrodeless plasma lamp 200 that is a fixed part of a lighting product or apparatus (e.g., a stage lighting installation, street and area lighting installations, or the like). The lamp body 202 and its associated components constitute a replaceable portion of the plasma lamp 200. The plasma lamp 200 further includes a securing arrangement in the form of a retaining component 206 and fasteners 208 to secure or hold captive the replaceable lamp body 202 at least partially within the lamp housing 204 (see FIG. 2B). In some example embodiments, the lamp body is almost fully received within the lamp housing when the plasma lamp is in its assembled form and operating.

The lamp housing 204 may be constructed out of cast metal or forged aluminum. The lamp housing 204 may have one or more air cavities 210 which may or may not be contiguous. The air cavity 210 may form the space that the other components, including the lamp body 202 will occupy. Accordingly, the lamp housing 204 may be shaped and dimensioned to receive the lamp body 202. In an example embodiment, the lamp housing includes a closure member such as a lid 212. The lid 212 may be a stamped sheet of aluminum, and serve to cover over an open top of the housing 204. In some embodiments, the housing 204 and the lid 212 form part of an electromagnetic shield or barrier to electromagnetic interference (EMI) emitted by the plasma lamp 200 during operation. Accordingly, the lid 212 may be coated with a compressible EMI gasket material to at least reduce or ideally eliminate RF energy leaks.

In an example embodiment, a light tunnel 214 is defined by a hole in the housing 204 to carry light from the bulb 216 back to a lamp control circuit (e.g., the lamp drive circuit 106 shown in FIG. 1). The lamp control circuit may monitor and control light output in a closed-loop fashion using a light-monitoring element, such as a photodiode (see the photodetector 134 shown in FIG. 1). A printed circuit board (PCB) 218 is provided to connect a high-power RF output of the lamp control circuit to the lamp body 202. In some example embodiments, the PCB 218 may also contain an EMI low-pass filter that effectively passes through power at the resonant frequency for lamp body 204, but rejects selected harmonics of that frequency. A trace 220 in the form of a strip of etched copper metal cladding may be provided on the PCB 218 to carry the RF power from the high-power RF output of the lamp control circuit to the lamp body 202. A socket or receptacle 222 is mounted and electrically coupled to the trace 220, and transfers the RF power from the trace 220 to an RF feed 224 (e.g., a drive probe 120), which is inserted into the receptacle 222. The receptacle 222 grasps the RF feed with some a spring force or bias, which arises from one or more spring clips internal to the receptacle 222. The spring clips may be deflected when the RF feed 224 is inserted. It is however to be noted that any removable coupling or socket may be provided which allows electrical coupling between the RF feed and the trace 220.

In the example plasma lamp 200, the receptacle 222 provides a first electrical connector forming part of the housing 204 and the RF feed 224 provides a second electrical connector that forms part of the lamp body 202. The first and second electrical connectors are releasable electrical connectors held together, for example with a friction fit. Accordingly, the first and second electrical connectors can be disengaged with relative ease without the use of a soldering iron or the like required for fixed connectors. In an example embodiment any releasable plug and socket arrangement suitable for coupling power between two conductors.

Several features shown in the plasma lamp 200 of FIG. 2A may ensure the proper thermo-mechanical interface between the lamp body 202 and the lamp housing 204. These include a thermally conductive material such as a thermal pad 226, and an alignment formation including, for example, an alignment pin 228. The thermal pad 226 may be made of a material with a thermal conductivity of approximately 1 W/m-K to 20 W/m-K or any value subsumed therein. The thermal pad 226 may provide uniform contact between the lamp body 202 and the housing 204, filling any small air gaps that would otherwise be present. The thermal pad 226 may ensure a predictable amount of heat transfer from the lamp body 202 to the lamp housing 204, regardless of the level of contact otherwise conferred by their local surface geometry. In an example embodiment, the thermal pad 226 may be advantageous for enabling replaceable lamp bodies to be used with plasma lamps. As shown by way of example in FIG. 2A, the thermal pad 226 is fixedly attached to the lamp housing 204 and snugly abuts the lamp body 202 when the lamp body 202 is received within the lamp housing 204.

The metal alignment pin 228 may facilitate locating the lamp body 202 with respect to the housing 204. The alignment pin 228 is received within an alignment aperture or hole 230 provided in the lamp body 202. This alignment formation, along with the RF feed 224 receivable within the receptacle 222, may provide proper alignment and faciliate that the following spatial relationships may be maintained. The lamp body 202 is centered relative to the housing cavity 210; this may facilitate the alignment of the bulb 216 to any optical elements (such as lenses or reflectors) in a lighting apparatus or product. When the bulb 216 has a tail 232, the tail 232 may be aligned with the light tunnel 214, so that light emitted from the tail 232 can illuminate the photodiode or other light measurement device (not shown) at the end of the light tunnel 214.

In an example embodiment, the lamp body 202 comprises a dielectric waveguide resonator that couples RF power to the bulb 216. The tail 232 of the bulb 216 may be an extension of its body and the tail 232 may not include any light emitting material. In an example embodiment, the tail 232 is a transparent piece of quartz rod. The tail 232 may transmit a small portion of the total light generated in the bulb 216 along to light tunnel 214 a photodetector connected to the lamp control circuit. In an example embodiment, the RF feed 224 couples power from the lamp control circuit in a resonant mode of the waveguide resonator that is suitable for delivering power to the bulb 216. The alignment hole 230 may be a relatively small hole in the lamp body 202 so as not to substantially perturb the operation of the waveguide resonator electric or magnetic fields. The alignment hole 230, together with the RF feed 224, may form the alignment mechanism or formation that locates the lamp body 202 properly with respect to the housing 204 when replacing the lamp body 202. Further, the alignment formation may be configured to align the lamp body 202 with the lamp housing 204 to facilitate engaging of the first and second electrical connectors.

The retaining component 206 may apply an appropriate amount of force with which to hold the lamp body 202 within the housing 204. The retaining component 206 may not only to ensure that the lamp body 202 does not inadvertently fall out of the housing 204, but it also apply the correct amount of force to sufficiently compress the thermal pad 226 to enable adequate thermal coupling between the lamp body 202 and the lamp housing 204. In an example embodiment, the retaining component 206 applies a spring force to the lamp body 202 through tightening of the fasteners 208. In an example embodiment, these fasteners 208 are easily accessible on the outside of the plasma lamp 200 such that a lamp service technician could easily loosen the fasteners 208 by hand, possibly while wearing protective gloves, and replace the lamp body 202. In order to do this, in some example embodiments the fasteners 208 include thumbscrews with head diameters of about 3 mm to 10 mm or any value subsumed therein. The retaining arrangement may also force the first and second electrical connectors to sufficiently engage so that a proper electrical connection is made.

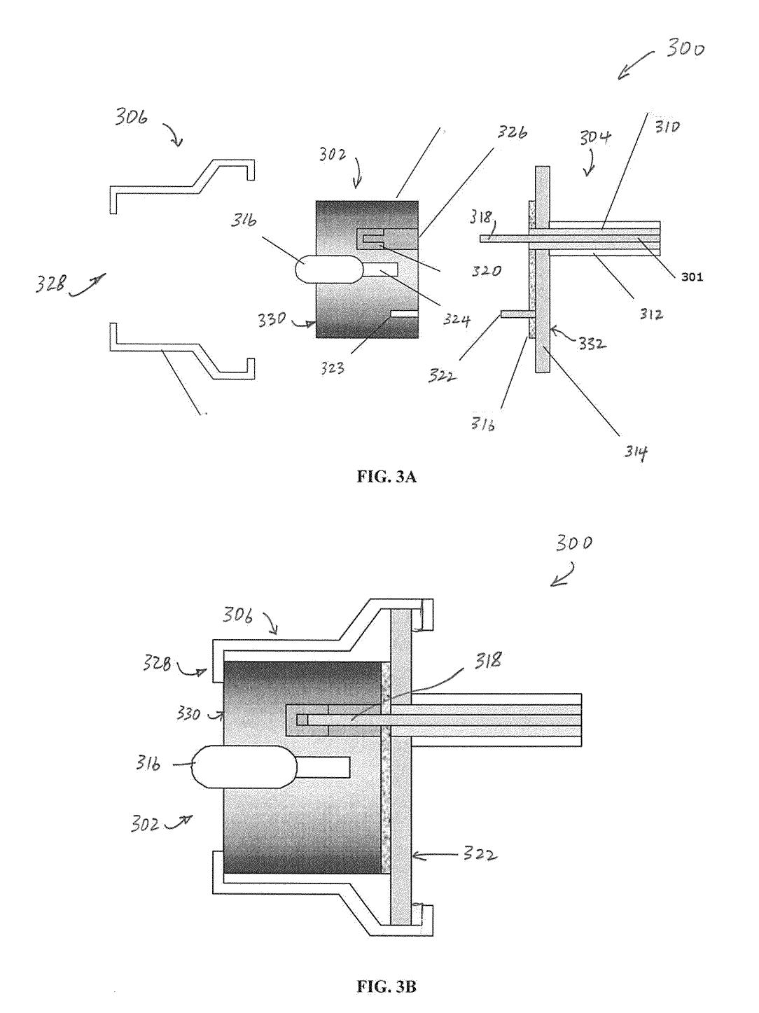

FIG. 3A shows an exploded cross-section view of a further plasma lamp 300, in accordance with an example embodiment, including a lamp housing 304 and replaceable lamp body 302. FIG. 3B shows an assembled cross-section view of the plasma lamp 300 of FIG. 3A. In the plasma lamp 300 an RF contact or receptacle may be advantageously provided inside the lamp body itself (e.g., in the dielectric material), rather than inside the lamp housing, as shown by way of example in the plasma lamp 200 of in FIGS. 2A and B. In an example embodiment, a lamp body 302 is tethered at an end of a cable (e.g., a coaxial cable) that may originate from a lamp control circuit provided, for example, in the lamp housing 304.

The cable supplying the lamp body 302 with RF power may have a metal center pin 308, an insulating layer 310, and a metal outer jacket 312. In some example embodiments, the outer jacket 312 may comprise multiple layers. The cable terminates in a mounting plate 314, which is grounded to the cable outer jacket 312, typically through a standard crimp connection. The insulating layer 310 and the center pin 308 protrude through the mounting plate 314, and the center pin 308 stands proud of the mounting plate 314. An EMI gasket 316 is layered onto the mounting plate 314 and may provide a leak-free contact between the lamp body 302 and the grounded mounting plate 314 of the lamp housing 304 when sufficiently compressed.

FIG. 3A clearly shows that the center pin 308 of the second connector being provided in the dielectric material cable defines an RF feed 318 to couple RF power into the lamp body 302. By designing an example lamp body 302 replaceable system this way, it may not be necessary to have a separate RF feed integral with the lamp body 302 as is the case with the lamp body 202 (see FIGS. 2A and 2B). Thus, in an example embodiment, the RF feed may define a first connector that releasable connects to a second connector provided in the lamp body. In the example plasma lamp 300, a receptacle 320 defines the second connector. An alignment pin 322 received within an aperture or hole 323 may perform the same function of the alignment pin 228 of the plasma lamp 200.

The lamp body 302 of the plasma lamp 300 may not differ substantially from the lamp body 202 of the plasma lamp 200. Example differences include the following. A bulb tail 324 of the plasma lamp 300 may or may not protrude entirely through the lamp body 302, as is the case in the bulb tail 232 of the plasma lamp 200. Instead of an RF feed 224, in an example embodiment the plasma lamp 300 incorporates an oversized hole 326 to receive biased (spring loaded) socket or receptacle 320. The function of the receptacle 320 may be identical to the function of the receptacle 222 of the plasma lamp 200. In an example embodiment, the receptacle 320 receives a tip of the RF feed 318, formed in the example embodiment by the center pin 308 of the coaxial cable, and holds it with some spring force. It is however to be noted that any socket or electrical contact that can electrically and releasable engage the RF feed 318 appropriately to ensure coupling of RF power into the lamp body 302 may be used in other example embodiments.

The plasma lamp 300 includes a retainer 306 that is similar in function to the retainer 206 of the plasma lamp 200. Unlike the retainer 206 that includes fasteners 208, the retainer 306 is a snap-fit. Accordingly, removal of the lamp body 302 from the lamp housing by, for example, a service technician may be greatly facilitated.

The retainer 306 is shown by way of example as a spring-loaded clip which engages on its one side with a front surface 330 of the lamp body 302, and on its other side to a back surface of 332 of the mounting plate 314 of the lamp housing 304. The retainer 306 may be designed to be easily removed and replaced in the field by a service technician, for example, who is likely to experience reduced manual dexterity due to wearing protective gloves at the time. The retainer 306 applies sufficient force to the lamp body 302 to compress it against the EMI gasket 316 and the mounting plate 314.

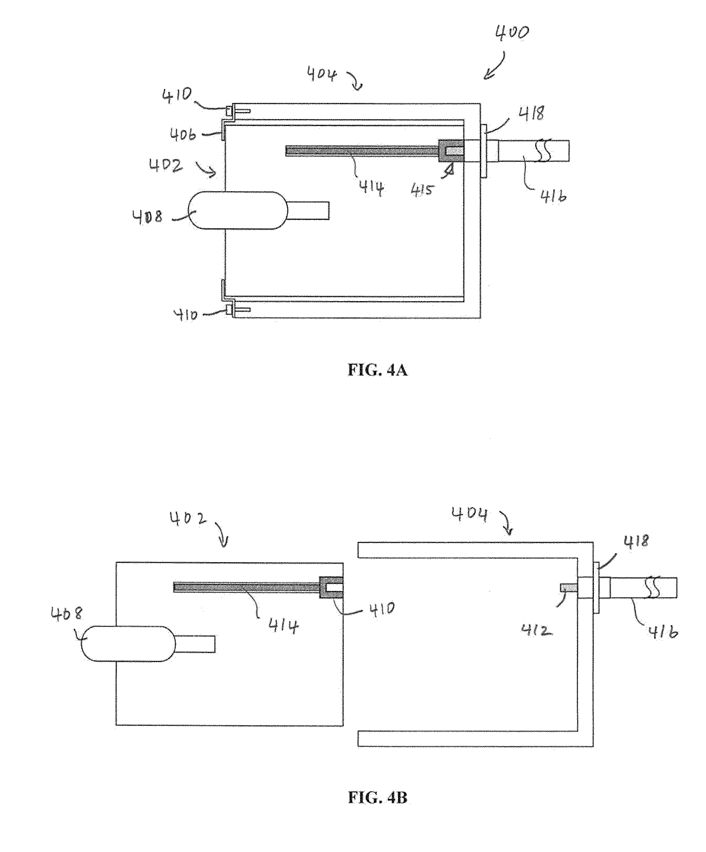

FIG. 4A shows an exploded cross-section view of a yet further plasma lamp 400, in accordance with an example embodiment, including a lamp housing 404 and replaceable lamp body 402. A retaining component 406 is optionally provided to removably retain the lamp body 402 within the lamp housing 404. FIG. 4B shows an assembled cross-section view of the plasma lamp 400 of FIG. 4A.

In an example embodiment, the lamp body 402 substantially resembles the lamp body 102 and some features of the lamp body 102 are not shown in FIGS. 4A and 4B for the sake of clarity. The plasma lamp 400 may, functionally, substantially resemble to plasma lamps 200 and 300 in that it includes a replaceable lamp body 402. For example, where the plasma lamp 400 is used in a lighting situation (e.g., street and area lighting, where a more permanent mounting of the lamp is provided), the lamp housing 404 is fixedly mounted to a support structure. In the event of the bulb 408 (or any part of the lamp body 402) failing, the lamp body 402 may be removed from the lamp housing 404 and replaced with a new lamp body. Accordingly, as in the case of the plasma lamps 200, 300, the retaining component 406 is configured to be relatively easily removable to facilitate replacing of the lamp body 402. Although the retaining component is shown as a clip secured to the lamp housing 404 using fasteners 410, it should be understood that other retaining arrangements may be used in other embodiments. In fact, any retaining arrangement may be used that retains the lamp body 402 in the lamp housing 404. For example a friction-fit retaining arrangement may be provides wherein the lamp housing 404 defines an opening to at least partially receive the lamp body 402, walls of the opening cooperating (e.g., frictionally) with side walls of the lamp body 402 to define the alignment arrangement.

The retaining component 406 may be configured to facilitate mating of a complementary coupling arrangement 415 provided by a socket or receptacle 410 and a pin 412 to establish an electrical connection between drive circuitry and an RF feed 414. The coupling arrangement 415 may comprise a first electrical connector defined, for example, by the pin 412 of the lamp housing 404, and a second electrical connector defined, for example, by the socket or receptacle 410 of the lamp body 402. In an example embodiment, the lamp housing receives RF power from the drive circuit via a coaxial cable 416 mounted to the lamp housing 404 by a coaxial cable connector 418. A center conductor of the coaxial cable 416 may define the pin 412. The receptacle 410 may include a biasing member (e.g., a spring-loaded contact) to electrically engage with the pin 412.

It is however to be appreciated that the complementary coupling arrangements shown in FIGS. 2A, 2B, 3A, 3B, 4A, and 4B may differ from one embodiment to another. It should thus be noted that any suitable releasable connector may be used to couple the RF power from the lamp housing 204, 304, 404 to the lamp body 202, 302, 402.

It is to be noted that the plasma lamps 200, 300 and 400 may similar in design to the plasma lamp 100. The various retaining formations to allow the plasma lamp 100 to function as a replacement lamp body 202, 302, 402 are not shown in FIG. 1. It should be noted that the plasma lamp 100 may include features of the plasma lamps 200, 330 and vice-versa.

In an example embodiment, the lamp body 402 is circular cylindrical in cross sectional shape and the lamp housing 404 has a circular cylindrical opening to at least partially receive the lamp body. In another example embodiment, the lamp body 402 is rectangular in cross sectional shape and the lamp housing 404 has a rectangular opening to at least partially receive the lamp body 404. As can be seen in FIGS. 4A and 4B, in an example embodiment the lamp body 402 is almost fully received within the lamp housing 404. It is however to ne noted that, in other example embodiments, the lamp body 402 may be fully received or only partially received within the lamp housing 404.

High frequency simulation software may be used to help select the materials and the shape of the lamp body 102, 202, 302, 402 and electrically conductive coating (electrically coating 108 in FIG. 1 and not shown in FIGS. 2A, 2B, 3A, 3B, 4A and 4B) to achieve desired resonant frequencies and field intensity distribution in the lamp body 102, 202, 302, 402. Simulations may be performed using software tools such as HFSS, available from Ansoft, Inc. of Pittsburgh, Pa., and FEMLAB, available from COMSOL, Inc. of Burlington, Mass. to determine the desired shape and dimensions of the lamp body 102, 202, 302, 402, resonant frequencies and field intensity distribution. The desired properties may then be fine-tuned empirically.

While a variety of materials, shapes and frequencies may be used, one example embodiment has a lamp body 102 designed to operate in a fundamental TM resonant mode at a frequency of about 880 MHz. The frequency may however be spread across a spectrum to reduce EMI and may also be adjusted based on load conditions or for brightness control. In this example, the plasma lamp 100 has an alumina lamp body 102 with a relative permittivity of 9.2. The lamp body 102 may have a cylindrical outer surface as shown with a recess 118 formed in the bottom surface. In an alternative embodiment, the lamp body 102 may have a rectangular outer surface. The outer diameter D1 of the lamp body 102 may be about 40.75 mm and the diameter D2 of the recess 118 may be about 8 mm. In an example embodiment, the lamp body 102 has a height H1 of about 17 mm. A narrow or thin region 112 forms a shelf over the recess 118. The thickness H2 of the narrow region 112 is about 2 mm. As shown in FIG. 1, in the narrow region 112 of the lamp body 102, the electrically conductive surfaces on the lamp body 102 are only separated by the narrow region 112 of a shelf in the lamp body 102. This results in higher capacitance in this region of the lamp body 102 and higher electric field intensities. In an example embodiment, this shape may support a lower resonant frequency than a solid cylindrical body having the same overall diameter D1 and height H1 or a solid rectangular body having the same overall width and height. For example, in some embodiments, the relative permittivity is in the range of about 9-15 or any range subsumed therein, the frequency of the RF power is less than about 1 GHz and the volume of the lamp body is in the range of about 10 cm³ to 30 cm³ or any range subsumed therein.

In the plasma lamp 100, a hole 110 is formed in the narrow region 112. The hole 110 may have a diameter of about 5.5 mm and the bulb 104 has an outer diameter of about 5 mm. The shelf formed by the narrow region 112 extends radially from the edge of the hole 110 by a distance D3 of about 1.25 mm. In an example embodiment, alumina powder is packed between the bulb 104 and the lamp body 102 and forms a layer having a thickness D5 of about ¼ mm. The bulb 104 has an outer length of about 15 mm and an interior length of about 9 mm. The interior diameter of the bulb 104 at the center is about 2.2 mm and the sidewalls have a thickness of about 1.4 mm. The bulb 104 protrudes from the front surface of the lamp body 102 by about 4.7 mm. The bulb 104 has a fill of Argon, Kr₈₅, Mercury and Indium Bromide. The pressure of the noble gas may be 400 Ton or more to reduce warm up times. This example pressure is measured at 22° C. (room temperature). It is understood that much higher pressures are achieved at operating temperatures after the plasma is formed. For example, the lamp 100, 200, 300 may provide a high intensity discharge at high pressure during operation (e.g., much greater than 2 atmospheres and 10-30 atmospheres or more in example embodiments). It will be noted that the bulbs 104, 216, 316, and 408 are substantially smaller than the lamp housing 204, 304, 404 and the lamp body 202, 302, 402.

The above dimensions, shape, materials and operating parameters are examples only and other embodiments may use different dimensions, shape, materials and operating parameters.

What is claimed is:

1. An electrodeless plasma lamp comprising:
a lamp housing including a first electrical connector operatively coupled a power source to provide radio frequency (RF) power; and
a lamp body including a second electrical connector to releasably engage with the first electrical connector of the lamp housing, the lamp body including a dielectric material having a relative permittivity greater than 2, the lamp body to couple the RF power to a bulb containing a fill that forms a light emitting plasma.

2. The plasma lamp of claim 1, further comprising a retaining arrangement releasably to retain the lamp body at least partially within the lamp housing.

3. The plasma lamp of claim 2, wherein the retaining arrangement comprises a retaining component that engages an upper surface of the lamp body and holds the lamp body captive at least partially within the lamp housing.

4. The plasma lamp of claim 1, wherein the lamp housing is shaped and dimensioned to receive the lamp body.

5. The plasma lamp of claim 4, wherein the lamp body is circular cylindrical in cross sectional shape and the lamp housing has a circular cylindrical opening to at least partially receive the lamp body.

6. The plasma lamp of claim 4, wherein the lamp body is rectangular in cross sectional shape and the lamp housing has a rectangular opening to at least partially receive the lamp body.

7. The plasma lamp of claim 1, further comprising an RF feed to provide the RF power to the lamp body, wherein the RF feed protrudes from the lamp body and defines the second electrical connector, the RF feed being receivable within a socket in the lamp housing that defines the first electrical connector.

8. The plasma lamp of claim 1, wherein the lamp housing comprises an RF feed that defines the first electrical connector, the RF feed being receivable within a socket that defines the second electrical connector.

9. The plasma lamp of claim 1, wherein the lamp body comprises an RF feed connected to the second electrical connector, the second connector being provided in the dielectric material.

10. The plasma lamp of claim 1, wherein the first electrical connector is a conductive pin and the second electrical connector is a socket to receive the pin.

11. The plasma lamp of claim 1, further comprising an alignment arrangement to align the lamp body with the lamp housing.

12. The plasma lamp of claim 11, wherein the lamp housing defines an opening to at least partially receive the lamp body, walls of the opening cooperating with side walls of the lamp body to define the alignment arrangement.

13. The plasma lamp of claim 11, wherein the alignment formation comprises:
a pin forming part of the lamp housing; and
an aperture defined in the lamp body to receive the pin and thereby align the lamp body with the lamp housing.

14. The plasma lamp of claim 11, wherein the alignment formation is configured to align the lamp body with the lamp housing to facilitate engaging of the first and second electrical connectors.

15. The plasma lamp of claim 1, further comprising a thermally conductive material that operatively facilitates conduction of heat from the lamp body to the lamp housing.

16. The plasma lamp of claim 15, wherein the thermally conductive material is fixedly attached to the lamp housing and snugly abuts the lamp body when the lamp body is received within the lamp housing.

17. A lamp body for an electrodeless plasma lamp assembly including a lamp housing, the lamp housing including a first electrical connector and the lamp body comprising:
a dielectric material having a relative permittivity greater than 2;
a bulb including a fill that forms a light emitting plasma when RF power is coupled by the dielectric material to the bulb; and
a second electrical connector to releasably engage with the first electrical connector of the lamp housing, the second electrical connector to connect the lamp body to the first electrical connector to receive the RF power.

18. The lamp body of claim 17, wherein the lamp body is shaped and dimensioned to be received at least partially within the lamp housing.

19. The lamp body of claim 17, further comprising an RF feed to provide the RF power into the lamp body, wherein the RF feed protrudes from the lamp body and defines the second electrical connector.

20. The lamp body of claim 17, wherein the lamp body comprises a socket that defines the second electrical connector.

21. The lamp body of claim 17, wherein the lamp body comprises an RF feed connected to the second electrical connector, the second connector being provided in the dielectric material.

22. The lamp body of claim 17, further comprising at least part of an alignment arrangement to align the lamp body with the lamp housing.

23. The lamp body of claim 22, wherein the lamp body comprises side walls that cooperate with walls of an opening in the lamp housing to define the alignment arrangement.

24. The lamp body of claim 22, wherein the alignment formation is configured to align the lamp body with the lamp housing to facilitate engaging of the first and second electrical connectors.

25. A lamp housing for an electrodeless plasma lamp assembly including a lamp body, lamp housing comprising:
a first electrical connector operatively coupled a power source to provide radio frequency (RF) power; and
an opening shaped and dimensioned to receive a lamp body, the lamp body including a second electrical connector to electrically engage with the first electrical connector of the lamp housing, the lamp body including a dielectric material having a relative permittivity greater than 2, the lamp body to couple the RF power to a bulb containing a fill that forms a light emitting plasma.

26. The lamp housing of claim 25, further comprising at least part of a retaining arrangement releasably to retain the lamp body at least partially within the lamp housing.

27. The lamp housing of claim 25, wherein the retaining arrangement comprises a retaining component that engages an upper surface of the lamp body.

28. The lamp housing of claim 25, wherein the lamp housing is shaped and dimensioned at least partially to receive the lamp body.

29. The lamp housing of claim 25, further comprising a circular cylindrical opening to at least partially receive the lamp body.

30. The lamp housing of claim 25, further comprising a rectangular opening to at least partially receive the lamp body.

31. The lamp housing of claim 25, further comprising an RF feed that defines the first electrical connector, the RF feed being receivable within a socket that defines the second electrical connector.

32. The lamp housing of claim 25, further comprising a thermally conductive material that operatively facilitates conduction of heat from the lamp body to the lamp housing.

33. The lamp housing of claim 32, wherein the thermally conductive material is fixedly attached to the lamp housing and snugly abuts the lamp body when the lamp body is received within the lamp housing.
